(19) United States
(12) Patent Application Publication
(10) Pub. No.: US 2009/0166909 A1
(43) Pub. Date: Jul. 2, 2009

(54) Temperature control system for molding facility

(75) Inventors: Shia Chung Chen, Taoyuan Hsien (TW); Yeon Pun Chang, Taoyuan Hsien (TW); Jen An Chang, Taoyuan Hsien (TW); Ping Shun Hsu, Taoyuan Hsien (TW)

Correspondence Address: CHARLES E. BAXLEY, ESQUIRE, 90 JOHN STREET, SUITE 309, NEW YORK, NY, 10038, US

(73) Assignee: Chung Yuan Christian University

(21) Appl. No.: 12/290,303

(22) Filed: Oct. 29, 2008

(30) Foreign Application Priority Data
Dec. 28, 2007 (TW) 096151050

(51) Int. Cl. B29C 45/78

(52) U.S. Cl. 264/40.6; 425/144

(57) ABSTRACT

A temperature control system includes a mold device having a mold cavity formed between two or more mold pieces for receiving a filling material, a number of detecting devices attached to the mold pieces for detecting the temperature of the mold pieces, a heating device for heating the mold pieces to a desired temperature, and a control module coupled to the mold pieces for closing and opening the mold cavity of the mold device, and for receiving the detected temperature signals from the detecting devices, and for controlling the heating device, such as for moving the heating device relative to the mold pieces of the mold device and for suitably pre-heating the mold pieces of the mold device.

### BACKGROUND OF THE INVENTION

1. Field of the Invention

The present invention relates to a temperature control system for a molding or mold injection machine or facility, and more particularly to a temperature control system including a control module for detecting and controlling the temperature of the mold device and for allowing the viscous material to be effectively sent or filled or injected into the mold device and for preventing the injection ports or mouths of the mold device to be blocked or interfered by the viscous material.

2. Description of the Prior Art

Typical molding devices or mold injection machines or facilities comprise a mold device which normally includes a mold cavity formed between two or more mold pieces, an injection device for filling or injecting the viscous material into the mold cavity of the mold device, and a heating machine or facility for heating the viscous material before the viscous material is filled or injected into the mold device and for allowing the viscous material to be effectively sent or filled or injected into the mold device.

For example, U.S. Pat. No. 6,919,545 to Chen, U.S. Pat. No. 6,960,746 to Chen, and U.S. Pat. No. 7,060,952 to Chen disclose three of the typical heating coil devices for instantly pre-heating the dies or the mold device and the viscous material, and for preventing the viscous material from being cooled, and for allowing the viscous material to be effectively sent or filled or injected into the mold device.

In the general procedure, the temperature detecting probes or the infrared temperature detecting or sensing devices are need to be attached and contacted with the mold devices in order to detect or to sense the temperature of the mold devices. However, the detected or sensed temperature of the mold devices may be different at different locations or positions of the mold devices. Some possible reasons comprise unequal measuring time, distinct contacting angles, and so on.

Therefore, one or more specially trained skilled persons or operators or workers are required for operating the mold device and the heating coil devices and the molding or mold injection machines or devices, in order to close and to open the mold device, and to operate the heating coil devices to heat the dies or the mold device and the viscous material, and also to operate the filling or injection device to fill or inject the viscous material into the mold cavity of the mold device.

The specially trained skilled persons or operators or workers are required to pay attention in operating the mold device and the heating coil devices and the molding or mold injection machines or devices at all time while operating the molding devices or mold injection machines or facilities, and it may cost a lot and it is time consuming to choose and to train or to educate the persons or operators or workers into the specially trained skilled persons or operators or workers.

Furthermore, after the temperature of the mold devices have been detected or sensed, it takes time to operate or to open or to close the mold devices and/or to fill or inject the viscous material into the mold cavity of the mold device, and the temperature of the mold devices may be changed, and different from the previous detected or sensed temperature such that the filling or injecting procedures may become failed and result defected products. In that case, the manufacturing cost would be greatly increased.

Accordingly, a temperature control system for precisely detecting and controlling the temperature of the mold device and for effectively sending or injecting the viscous material into the mold device and for precisely controlling the opening and the closing of the mold device is desired to be developed.

The present invention has arisen to mitigate and/or obviate the afore-described disadvantages of the conventional temperature control problems for the typical molding or mold injection machines or devices.

### SUMMARY OF THE INVENTION

The primary objective of the present invention is to provide a temperature control system including a control device for detecting and controlling the temperature of the mold device and for allowing the viscous material to be effectively sent or filled or injected into the mold device and for preventing the injection ports or mouths of the mold device to be blocked or interfered by the viscous material.

In accordance with one aspect of the invention, there is provided a temperature control system comprising a mold device including at least two mold pieces, and including a mold cavity formed between the mold pieces for receiving a filling material, a number of detecting devices attached to the mold pieces of the mold device for detecting a temperature of each detecting point of the mold pieces of the mold device, a heating device for heating the mold pieces of the mold device to a desired temperature, and a control module coupled to the mold pieces of the mold device for closing and opening the mold cavity of the mold device, and coupled to the detecting devices for receiving detected temperature signals from the detecting devices, and coupled to the heating device for controlling the heating device.

In accordance with another aspect of the invention, there is provided a method for controlling a temperature of a mold device, comprising providing a heating device, operating a control module to actuate the heating device to heat at least two mold pieces of the mold device, operating the control module to control the temperature and a heating time of the mold device, and stopping heating the mold device when the mold pieces of the mold device are heated uniformly to a desired temperature, whereby, the present invention may fully control and automatically preheat the mold device according to the making materials for the mold device, and the required heating power, and the time control for the heating device to the mold device, and may precisely control the heating temperature of the mold device for allowing the molded product to be made or formed with the required characteristics, and the proportion of the defective may be reduced, and the manufacturing operation may be facilitated, such that the economical effect may be increased.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a temperature control system in accordance with the present invention for a molding or mold injection machine or device;

FIG. 2 is a block diagram or flow chart illustrating the operation processes or procedures for the temperature control system;

FIG. 3 is a plan schematic view illustrating one of the control interfaces of a control module for the temperature control system;

FIG. 4 is another plan schematic view similar to FIG. 3, illustrating the other control interface of the control module for the temperature control system; and

FIG. 5 is a further plan schematic view similar to FIGS. 3 and 4, illustrating the further control interfaces of the control module for the temperature control system.

### DETAILED DESCRIPTION OF THE PREFERRED EMBODIMENT

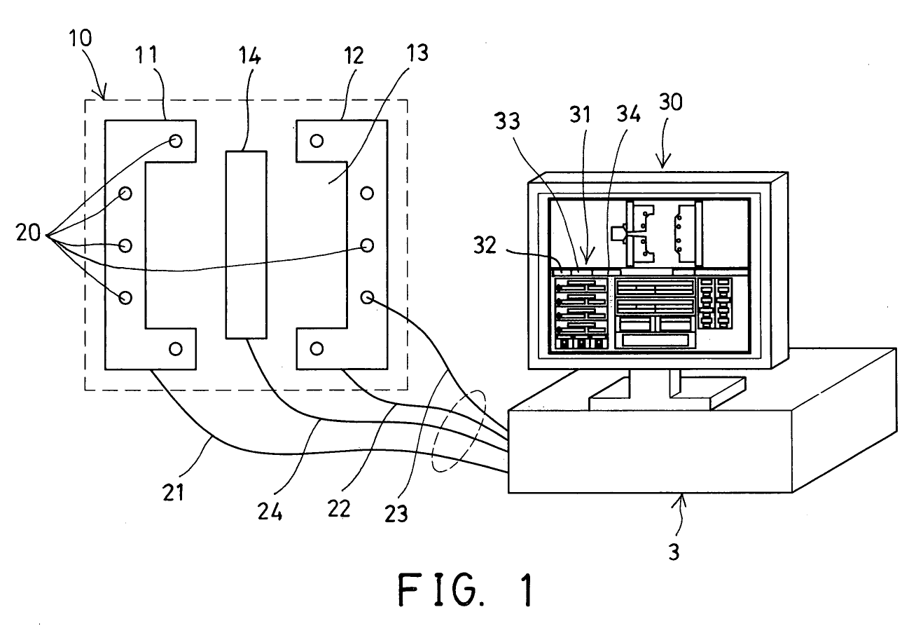

Referring to the drawings, and initially to FIG. 1, a temperature control system for a molding facility in accordance with the present invention is provided for detecting and controlling the temperature of a mold device 10 and for allowing the viscous material or filling material to be effectively sent or injected into the mold device 10 and for preventing the injection ports or mouths of the mold device 10 to be blocked or interfered by the filling material, the mold device 10 of the temperature control system comprises two or more mold pieces 11, 12 including a mold cavity 13 formed between the mold pieces 11, 12 for receiving the filling material. The mold pieces 11, 12 may be made of various metal materials, selected from such as aluminum, iron, copper or the alloy or the combination thereof or the like, and may be moved toward each other for closing the mold cavity 13 and may also be moved away from each other for opening the mold cavity 13.

A heating device 14 is provided for heating the mold device 10 and/or the filling material to a desired temperature and for allowing the filling material to be effectively sent or filled or injected into the mold cavity 13 of the mold device 10, and/or to be completely filled within the mold cavity 13 of the mold device 10. The heating device 14 may also be moved relative to the mold cavity 13 and/or the mold pieces 11, 12 for suitably heating the mold device 10 and/or the filling material. Three examples of the heating devices, such as the typical heating coil devices have been disclosed in U.S. Pat. No. 6,919,545 to Chen, U.S. Pat. No. 6,960,746 to Chen, and U.S. Pat. No. 7,060,952 to Chen which may be taken as the references for the present invention. The above-described structure is typical and will not be described in further details.

The temperature control system in accordance with the present invention further comprises a number of detecting means or devices 20, such as temperature probes or sensing or detecting members or devices 20 are attached to or embedded into the mold pieces 11, 12 and/or the mold device 10 for sensing or detecting the temperature of each detecting point of the mold pieces 11, 12 and/or the mold device 10 and/or of the filling material, and the temperature control system further comprises a processor unit or control module 3 coupled to the mold pieces 11, 12 of the mold device 10 and/or the temperature detecting devices 20 and the heating device 14 with electric cables or wires 21, 22, 23, 24 for receiving the detected temperature signals or information from the temperature detecting devices 20 and/or the mold pieces 11, 12 of the mold device 10, and/or for moving the mold pieces 11, 12 relative to each other, and/or for moving the heating device 14 relative to the mold cavity 13 and/or the mold pieces 11, 12, and/or for energizing or operating the heating device 14 to heat the mold device 10 and/or the filling material.

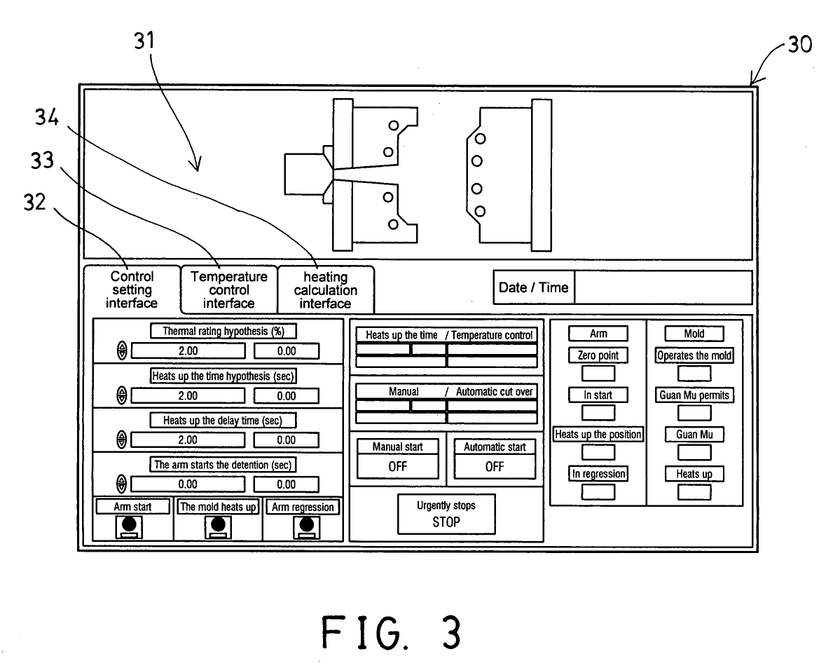

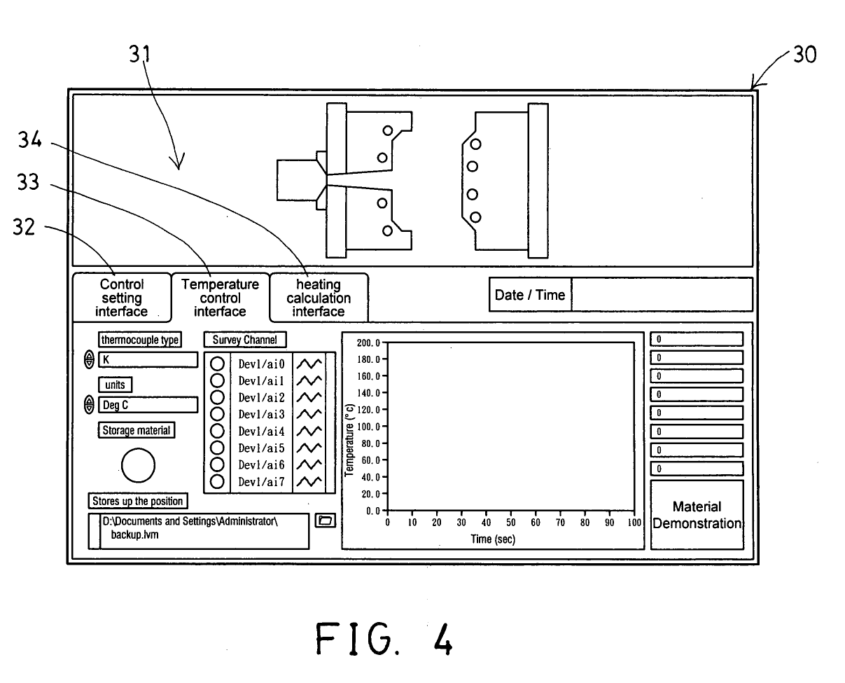

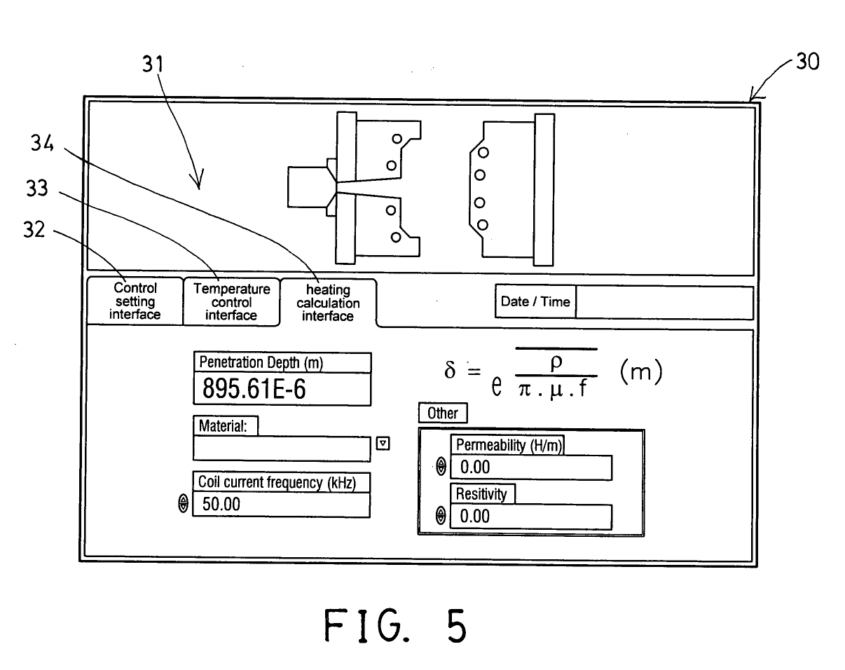

The control module 3 include a monitor 30, and a computer program 31 having one or more (such as three) user interfaces 32, 33, 34 (FIGS. 1 and 3-5) displayed or shown in the monitor 30, and for controlling the mold pieces 11, 12 of the mold device 10, the temperature detecting devices 20, and the heating device 14. For example, as shown in FIG. 3, the control setting interface 32 may be provided for setting such as the heating rate or power, the heating time, the heating time interval, the heating time delay, and the energizing or operating of the heating device 14, for setting or controlling or monitoring various temperature information or data or signal of the mold pieces 11, 12 of the mold device 10 and/or of the temperature detecting devices 20, and/or of the heating device 14.

The temperature control interface 33 may be provided for setting or selecting such as the types, the units or the other information or data of the thermocouple in order to take or to obtain the desired temperature information or data or signal from the temperature detecting devices 20 and for detecting or measuring or obtaining the temperature changing or variation of the mold pieces 11, 12 of the mold device 10 and/or of the temperature detecting devices 20. The heating calculation interface 34 may be provided for setting or selecting such as the making materials for the mold pieces 11, 12 of the mold device 10, for setting the permeability, the reset error, and/or the coil current frequency of the heating device 14, etc.

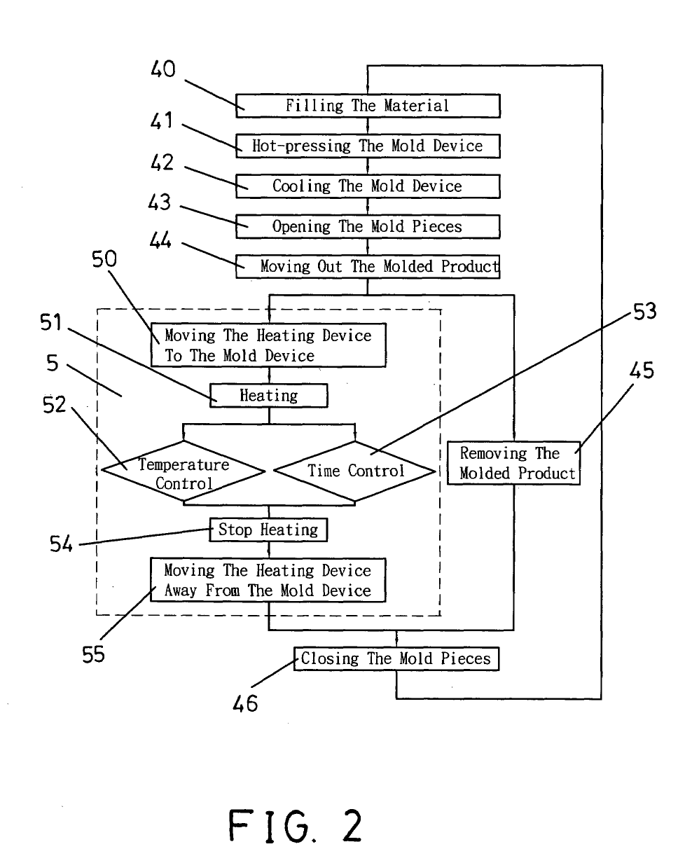

In operation, as shown in FIG. 2, the control module 3 is provided for controlling the pre-heating of the mold pieces 11, 12 of the mold device 10 when or after the molded product is taken out or removed from the mold pieces 11, 12 of the mold device 10, or before or after the mold pieces 11, 12 of the mold device 10 have been moved toward each other for closing the mold cavity 13 of the mold device 10 and for the next molding or mold injection process or procedure. Normally, when the mold device 10 is prepared or ready, the filling material is filled or injected into the mold cavity 13 of the mold device 10 in process 40, hot-pressed in the mold device 10 for a predetermined time interval in process 41, cooling the mold device 10 in process 42, opening the mold pieces 11, 12 of the mold device 10 in process 43, moving or protruding the molded product out of the mold device 10 in process 44, removing the molded product out of the mold device 10 in process 45, and closing the mold pieces 11, 12 of the mold device 10 again in process 46 and ready for the next molding or mold injection process or procedure.

The control module 3 is provided for controlling the pre-heating of the mold pieces 11, 12 of the mold device 10 with a controlling cycle 5 when or after the molded product is taken out or removed from the mold pieces 11, 12 of the mold device 10, or before or after the mold pieces 11, 12 of the mold device 10 have been moved toward each other for closing the mold cavity 13 of the mold device 10, and/or before the next molding or mold injection process or procedure is operated or conducted. For example, the controlling cycle 5 includes moving the heating device 14 relative to the mold cavity 13 and/or the mold pieces 11, 12 to the desired or selected position in process 50, heating the mold pieces 11, 12 of the mold device 10 in process 51, controlling the heating temperature of the mold device 10 in process 52, controlling the heating time for the mold device 10 in process 53, stop heating in process 54 when the temperature of each detecting point of the mold pieces 11,12 is equal to or more than a desired temperature, and moving the heating device 14 away from the mold cavity 13 and/or the mold pieces 11, 12 in process 55.

After the mold pieces 11, 12 of the mold device 10 have been pre-heated to the desired or selected temperature, the mold pieces 11, 12 of the mold device 10 may be moved toward each other to close the mold cavity 13 of the mold device 10 again in process 46 and ready for the next molding or mold injection process or procedure, and for allowing the viscous or filling material to be effectively sent or filled or injected into the mold cavity 13 of the mold device 10 in process 40, and for allowing the viscous or filling material to be completely filled in the mold cavity 13 of the mold device 10, in order to obtain the best products and for reducing the defectives, and/or for preventing the defectives from being generated.

It is to be noted that the mold pieces 11, 12 of the mold device 10, the temperature detecting devices 20, and the heating device 14 may be suitably operated or controlled with or by the control module 3 in order to suitably pre-heat the mold pieces 11, 12 of the mold device 10 to the desired or selected temperature and thus to allow the viscous or filling material to be effectively sent or filled or injected into the mold cavity 13 of the mold pieces 11, 12 of the mold device 10 and for preventing the injection ports or mouths of the mold device to be blocked or interfered by the viscous or filling material. No specially trained skilled persons or operators or workers are desired for operating the mold device 10 and the heating device 14 and the molding or mold injection machines or devices.

Accordingly, the temperature control system in accordance with the present invention includes a control module for detecting and controlling the temperature of the mold device and for allowing the viscous material or filling material to be effectively sent or injected into the mold device and for preventing the injection ports or mouths of the mold device to be blocked or interfered by the viscous or filling material.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A temperature control system for a molding facility comprising:
a mold device including at least two mold pieces, and including a mold cavity formed between said at least two mold pieces for receiving a filling material;
a plurality of detecting devices attached to said at least two mold pieces of said mold device for detecting a temperature of each detecting point of said at least two mold pieces of said mold device;
a heating device for heating said at least two mold pieces of said mold device to a desired temperature; and
a control module coupled to said at least two mold pieces of said mold device for closing and opening said mold cavity of said mold device, and coupled to said detecting devices for receiving detected temperature signals from said detecting devices, and coupled to said heating device for controlling said heating device.

2. The temperature control system as claimed in claim 1, wherein said at least two mold pieces of said mold device are made of metal materials.

3. The temperature control system as claimed in claim 2, wherein the metal materials are selected from the group consisting of aluminum, iron, copper and the combination thereof.

4. The temperature control system as claimed in claim 1, wherein said detecting devices are temperature probes.

5. The temperature control system as claimed in claim 1, wherein said control module comprises:
a control setting interface for setting a heating power, a heating time, a heating time interval, and moving said heating device relative to said at least two mold pieces of said mold device,
a temperature control interface for monitoring a temperature changing of each detecting point of said at least two mold pieces of said mold device, and
a heating calculation interface for selecting a making material for said at least two mold pieces of said mold device.

6. The temperature control system as claimed in claim 5, wherein said temperature control interface is provided for setting a type and a unit of a thermocouple.

7. The temperature control system as claimed in claim 5, wherein said heating calculation interface is provided for setting a permeability, a reset error, and a coil current frequency of said heating device.

8. The temperature control system as claimed in claim 1, wherein a heating, a closing and an opening of said mold device are automatically operated with said detecting devices, said heating device and said control module.

9. A method for controlling a temperature of a mold device, said mold device including at least two mold pieces, and including a mold cavity formed between said at least two mold pieces for receiving a filling material, said method comprising:
heating said at least two mold pieces of said mold device by a heating device;
detecting a temperature of each detecting point of said at least two mold pieces of said mold device by a plurality of detecting devices attached to said at least two mold pieces of said mold device;
stopping heating said mold device when the temperature of each detecting point is equal to or more than a desired temperature.

10. The method as claimed in claim 9, wherein the heating condition of said mold device is determined according to a material for making said at least two mold pieces of said mold device, a heating power, a heating time, a heating time interval, and moving said heating device relative to said at least two mold pieces of said mold device, a permeability, a reset error, and a coil current frequency of said heating device.

11. The method as claimed in claim 9, wherein the detected temperature is presented by setting a type and a unit of a thermocouple.

12. The method as claimed in claim 9 further comprising moving said heating device close to said at least two mold pieces of said mold device before heating said at least two mold pieces of said mold device.

13. The method as claimed in claim 9 further comprising moving said heating device away from said at least two mold pieces of said mold device after stopping heating said mold device.

14. The method as claimed in claim 9 further comprising closing said at least two mold pieces of said mold device, filling a filling material into the mold device, hot-pressing the mold device for a predetermined time interval, cooling the mold device, opening the mold device, and protruding a molded product out of the mold device.
